(19) United States
(12) Patent Application Publication
(10) Pub. No.: US 2013/0342897 A1
(43) Pub. Date: Dec. 26, 2013

(54) SUN REFLECTOR FOR WINDOWS

(71) Applicant: Cate RUSHFORTH, Kanata (CA)

(72) Inventor: Cate RUSHFORTH, Kanata (CA)

(21) Appl. No.: 13/870,001

(22) Filed: Apr. 25, 2013

Related U.S. Application Data
(60) Provisional application No. 61/663,157, filed on Jun. 22, 2012.

(30) Foreign Application Priority Data
Feb. 15, 2013 (CA) 2,806,091

(51) Int. Cl. G02B 5/08; B32B 38/00

(52) U.S. Cl. CPC G02B 5/08; B32B 38/0004
USPC 359/350; 156/510

(57) ABSTRACT

A heat reflector for temporarily covering of a window or a door to reflect sunlight and reduce heat transfer therethrough includes a metallized, biaxially-oriented polyethylene terephthalate sheet. The heat reflector can be sold in kit form comprising the sheet of metallized polyethylene foil; a cutting element for cutting the sheet of metallized polyethylene foil to fit the window or door; a mounting element for temporarily mounting the polyethylene foil layer onto a window or door; and a squeegee for smoothing out the metallized polyethylene foil on the window or door.

### CROSS-REFERENCE TO RELATED APPLICATIONS

The present invention claims priority from Canadian Patent Application No. 2,806,091 filed Feb. 15, 2013, and U.S. Provisional Patent Application No. 61/663,157 filed Jun. 22, 2012, which are incorporated herein by reference.

### TECHNICAL FIELD

The present invention relates to a sun reflector foil for glass windows and doors, and in particular to a sun reflector kit for applying a sun reflector foil to windows and doors.

### BACKGROUND OF THE INVENTION

Typically in northern climates there are only about two months of true summer weather, and only a few weeks with truly hot temperatures. Accordingly, some people consider it a waste of money and energy to purchase, run and maintain an air conditioning unit for such a short period of time. Running an air-conditioner at 21° C. (typically costs more than $200/month for an average house. During the summer months, hydro consumption increases as much as 25% due to use of air conditioners. Utility companies often resort to the more polluting power generation such as coal plants, to meet this increased demand. Accordingly, finding alternative solutions for reducing uncomfortably high levels of heat can decrease peak demand for energy, thereby generating environmental benefits and cost savings for the home owner.

Due to heavily insulated walls, much of the heat enters a dwelling via radiation of the sun's rays through the windows, doors or other transparent portals, e.g. patio doors. Single pane glass will let in 84% of heat, while standard double pane windows allow 71% of heat to transfer. A 4×4 window with direct sun lets in over 2000 BTU/hr of heat (equivalent to 600 kw heater). Double and triple pane windows with inert gas fillers minimize heat conduction, but surprisingly even argon filled windows allow 62% heat transfer. “Low-E” coatings for windows and doors attempt to minimize radiation; however, they still do not go far enough to reflect the majority of the suns radiation.

Window films have also been used to reflect sunlight in the past; however, these films are manufactured with a near permanent adhesive, which last for up to 10 years and cannot be removed, without destroying the film, for the other three seasons, when the extra heat from the sun is used to offset residential heating costs. Accordingly, conventional window films are counterproductive in northern climates with multiple seasons. Most of these conventional films only reflect up to 40% of the sunlight and radiant heat, and are designed to be unnoticeable to the naked eye, providing limited effect and no privacy at any time.

The application process for films is also more complicated than is the case for the current invention, because there is a protective layer that must be peeled of, both making the product difficult to work with and creating waste. Furthermore, the permanent adhesive does not allow for multiple adjustments, resulting in failed mounting attempts, making the products less appealing to do-it-yourself homeowners. The films may also be hazy for 5-10 days while the adhesive cures. Air bubbles will typically occur and disappear after the curing process is done, but if the air bubbles do not disappear, new product must be purchased and applied. The films, which are substantially thicker than the present invention and include complex adhesives and waste material, i.e. the film backing which is peeled off, are also more expensive than the present invention.

Alternatively, people cover their windows with thick aluminum foil, e.g. 6 um thick, which blocks all oxygen, moisture and light, but results in a very unattractive display, defeating the purpose of the window.

An object of the present invention is to overcome the shortcomings of the prior art by providing a radiation reflecting foil for temporarily covering glass windows and doors during the hot summer days and months to greatly reduce the transfer of heat via the sun's rays, while enabling the foil to be manually applied, removed and reinstalled whenever desired.

Another object of the present invention is to provide privacy for the inside of a home or building during the day, when the sunlight is brighter than the inside light, while enabling the occupants of the home or building to observe the outside.

### SUMMARY OF THE INVENTION

Accordingly, the present invention relates a heat reflector for use in covering transparent panel to reflect the sunlight from entering a building comprising: a polyethylene substrate layer; a metallized material in or on the polyethylene film layer forming a foil to increase reflectivity to between about 40% and about 99% of the sunlight; and a mounting element for temporarily mounting the foil onto a window or door and enabling manual removal and reinstallation at any time.

In a preferred embodiment the foil reflects about 90% to about 99% of the sunlight providing privacy from outside the building looking in, while providing transparency from inside the building during daytime, while the sun is shining.

Another aspect of the present invention relates to the use of a heat reflector comprising a metallized, bi-axially-oriented polyethylene terephthalate foil sheet for temporarily covering a transparent panel to reflect between about 40% to about 99% of sunlight from entering a building and reduce heat transfer therethrough, and manual removal and reinstallation whenever desired.

In a preferred embodiment use the foil reflects about 90% to about 99% of the sunlight providing privacy from outside the building looking in, while providing transparency from inside the building during daytime, while the sun is shining.

Another feature of the present invention provides a kit for mounting a sunlight reflector onto a transparent panel mounted on a building comprising: a sheet of metallized polyethylene heat-reflective foil for reflecting about 40% to about 99% of sunlight from entering a building, a cutting element for cutting the sheet of metallized polyethylene foil to fit the transparent portal; a mounting element for temporarily mounting the sheet onto a transparent portal, and for enabling manual removal and reinstallation at any time; and a squeegee for smoothing out the sheet on the transparent portal.

In a preferred embodiment the foil in the kit reflects about 90% to about 99% of the sunlight providing privacy from outside the building looking in, while providing transparency from inside the building during daytime, while the sun is shining

Yet another aspect of the present invention relates to a method of preventing the transfer of heat through a transparent panel mounted between an inside and an outside of a building, comprising: cutting a sheet of metallized polyethylene foil to fit the transparent panel; applying a temporary adhesive material to the sheet or the transparent panel enabling manual application, removal and reinstallation of the sheet without damaging the sheet; mounting the sheet of metalized polyethylene foil onto the transparent panel; and smoothing out the sheet of metallized polyethylene foil on the transparent panel; wherein the metalized polyethylene foil has a thickness which reflects about 40% to about 99% of the sunlight while appearing transparent from inside the building and opaque from outside the building during daytime.

In a preferred method the foil reflects about 90% to about 99% of the sunlight providing privacy from outside the building looking in, while providing transparency from inside the building during daytime, while the sun is shining

### BRIEF DESCRIPTION OF THE DRAWINGS

The invention will be described in greater detail with reference to the accompanying drawings which represent preferred embodiments thereof, wherein:

FIG. 1 is a cross-sectional view of the radiation reflector in accordance with the present invention mounted on a window; and

FIG. 2 is a isometric view of a radiation reflector kit in accordance with the present invention.

### DETAILED DESCRIPTION

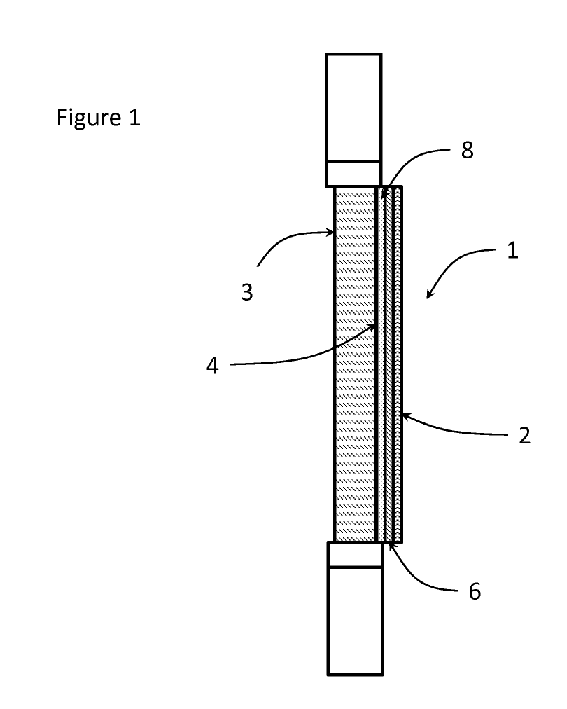

With reference to FIG. 1, the solar reflector 1 of the present invention includes a radiation reflecting foil 2 that can easily be applied to transparent panels 3 mounted on a building, such as windows and doors, using a suitable mounting element 4, e.g. temporary adhesive material, during summer months, and then easily removed during the fall or on days when the foil 2 is not required. The term transparent panel is used interchangeably with term window to refer to any transparent or semi-transparent pane of glass or other material used in windows or doors to enable light to enter a building, home or other structure.

Ideally, the radiation reflecting foil 2 is transparent from the side without the light source, i.e. the inside during the day, and the outside during the night. The light from the bright room reflected from the foil back into the room itself is much greater than the light transmitted from the dark room, overwhelming the small amount of light transmitted from the dark to the bright room; conversely, the light reflected back into the dark side is overwhelmed by the light transmitted from the bright side. This allows a viewer in the dark side to observe the bright room covertly.

An example of an inexpensive and easily acquired base or substrate material is biaxially-oriented polyethylene terephthalate (boPET) originally developed in the mid 1950's by DuPont and used for space suits, emergency blankets and sails. Alternatives include polypropylene, PET, nylon, polyethylene and cast polypropylene. Typically, the substrate is approximately 10 um to 1000 um thick, preferably 10 um to 100 um thick.

BoPET is a polyester substrate made from stretched polyethylene terephthalate (PET) and has the following properties: high tensile strength, chemical and dimensional stability, transparency, reflectivity, gas and aroma barrier properties and electrical insulation. The sun reflector 1 according to the present invention includes some form of metal material to increase the reflectivity of the sun reflector to from about 40% to about 99%. Ideally, a metallized layer 6, e.g. applied by vapor deposition onto the boPET substrate, of a thin layer of evaporated aluminum, gold, or other metal is provided, e.g. a thickness of between about 0.0025 um and about 0.025 um. In another embodiment, the aluminum layer 6 is between about 0.01 um and about 0.025 for reflecting about 80% to about 99% of the sunlight and heat.

In the preferred embodiment in which approximately 90% to 99% of the sunlight is reflected the layer of aluminum 6 is of less than about 0.025 um, and greater than about 0.015 um (150 Å to 250 Å) and most preferably between about 0.016 um and about 0.024 um, although other covering or injection methods are possible. Ideally, the aluminum layer is thin enough to be partially transparent on the side of the foil with less light, while appearing opaque, i.e. providing privacy, from the side with the most light to the side with less light, e.g. people inside of the dwelling can see out when the sun is out during the daytime, while people outside the dwelling cannot see in. The resultant foil material is much less permeable to gases, e.g. 50 to 150 ccm/m²/day of oxygen, and less than 1 to 50 g/m²/day of water vapor, but still provides for some “breathing”, and reflects at least 90% and up to 99% of light and heat, including much of the infrared, visible and ultra violet spectrum, while letting a small percentage of light in to provide limited transparency, i.e. for aesthetics. Aluminized boPET film can also be laminated with a layer of polyethylene 8, which provides sealability and improves puncture resistance. The polyethylene side 8 of such a laminate appears dull and the PET side 2 appears shiny providing the user with the option of having shiny or dull appearing windows.

A variety of companies manufacture boPET and other polyester materials under different brand names. In the UK, Canada and the US, the most well-known trade names are Mylar®, Melinex® and Hostaphan®.

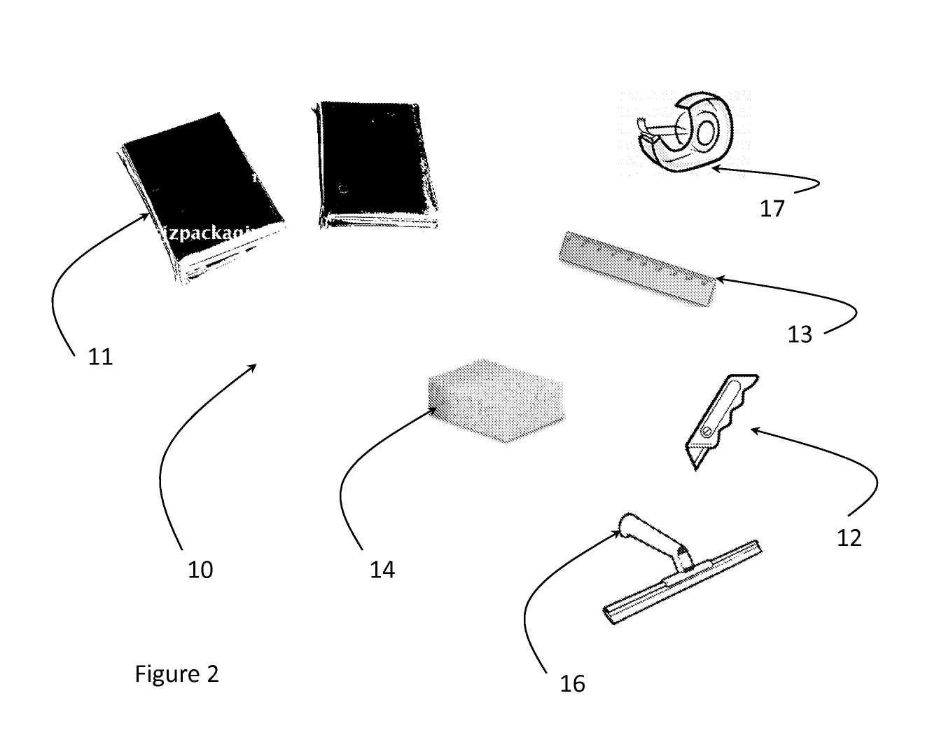

With reference to FIG. 2, the present invention also relates to a kit 10 for mounting the solar reflector foil onto windows and doors. Each solar reflector kit 10 will include a section of transparent, radiation reflecting foil, preferably metallized polyester foil 1, more preferably a metallized boPET foil, and ideally 48 gauge aluminum boBET foil, i.e. 12-13 um thick. Each kit 10 can include a large section of reflector foil 1, which the homeowner will have to cut to suite their window requirements or each kit can include one or more sections 11 of reflector foil pre-cut into pre-determined sizes, based upon the standard windows and doors, e.g. a standard size (30″×64″) for standard windows, a large size (59×84″) for larger window, and a patio door size (35″×72″) for patio doors.

The kit 10 may include a cutting instrument, such as scissors or a retractable utility knife 12, for cutting the section of reflector foil 11 to fit the windows exactly. A large straight edge, such as a 6″ flat wooden stick 13, can be provided to facilitate the cutting of the foil sections 11. During cutting with the utility knife 12, the straight edge is used to hold a portion of the foil section 11 down against a hard surface, and to provide a straight-edge guide for the cutting instrument 12.

Once the foil section 11 are cut to fit the window, a temporary adhesive material is applied to the window (or the foil section 11) as a mounting element. Ideally, a mild soap or shampoo solution, e.g. 1 drop of dish soap per 1-2 cups of water, which may or may not be provided in the kit 10, is evenly applied to the entire glass portions of the window, using a sponge 14, ideally provided in the kit 10. Alternatively, a suitable temporary or weak adhesive layer can be provided on a surface or at specific areas of the foil section 11. The cut foil section 11 can then be mounted on the window and moved around to fit perfectly. The adhesive is only temporary and enables the foil section 11 to be manually removed easily whenever desired, i.e. with no additional chemicals, power tools or machines, every day, week, month or season, without damaging the sheet, thereby enabling reinstallation of the sheet, as needed.

The kit 10 also includes a squeegee 16, e.g. 6 to 12 inches wide, for straightening, smoothing and adhering the reflector foil section 11 to the glass window pane. Ideally, the squeegee 16 includes a silicon head to reduce friction between the squeegee 16 and the reflector foil 11 for preventing the foil from getting scratched or tearing.

The mounting element can also include tape 17, ideally in the form of a small roll of clear tape, provided for anchoring the reflector foil section 11 in place, and for fixing any scratches or tears that may have occurred during the mounting process. The aforementioned steps are then repeated for each window in the house.

While window films remain on the window for all four seasons and last for up to ten years, the foil sheets in accordance with the present invention are mounted for ten to twelve weeks only and are then disposed of after the summer. The window foil can also be temporarily removed on cloudy days or when you want unobstructed views, and then reapplied. Most of the films reflect less than 40% of the radiant heat, while the preferred window foils reflect over 90% of the sunlight and radiant heat. The foil in accordance with a preferred embodiment of the present invention appears opaque from the outside during the day, thereby providing privacy, but is also partially transparent from the inside, enabling the home owner to see the view outside while controlling the climate inside, unlike typical aluminum foils that are surprisingly used by many throughout Canada and the United States, during heat waves.

The use of the foil of the present invention, as opposed to the prior art films, offers the advantages of greater ease of application, elimination of the need for special adhesives, reduced waste and greater ease of removal and reuse, as desired.

We claim:

1. Use of a heat reflector comprising a metallized, bi-axially-oriented polyethylene terephthalate foil sheet, and a temporary mounting material, for temporarily covering a transparent panel to reflect between about 40% and about 99% of sunlight from entering a building and reduce heat transfer therethrough, while providing for manual removal and reinstallation of the heat reflector whenever desired.

2. The use according to claim 1, wherein the metallized, bi-axially-oriented polyethylene terephthalate foil sheet, includes aluminum.

3. The use according to claim 2, wherein the aluminum has a thickness of between about 0.0025 um and about 0.025 um; whereby the foil sheet reflects about 80% to about 99% of sunlight, while appearing transparent from inside the building and opaque from outside the building during daytime.

4. The use according to claim 2, wherein the aluminum has a thickness of between about 0.015 um and about 0.025 um; whereby the foil sheet reflects about 90% to about 99%, while appearing transparent from inside the building and opaque from outside the building during daytime.

5. A kit for mounting a heat reflector onto a transparent panel mounted on a building comprising:
a sheet of metallized polyethylene heat-reflective foil for reflecting about 40% to about 99% of sunlight from entering a building;
a cutting element for cutting the sheet of metallized polyethylene foil to fit the transparent portal;
a mounting element for temporarily mounting the sheet onto a transparent portal, and for enabling manual removal and reinstallation at any time; and
a squeegee for smoothing out the sheet on the transparent portal.

6. The kit according to claim 5, wherein the metallized polyethylene foil comprises biaxially-oriented polyethylene terephthalate.

7. The kit according to claim 6, wherein the metallized polyethylene foil includes aluminum.

8. The kit according to claim 7, wherein the aluminum has a thickness of between about 0.0025 um and about 0.025 um; whereby the foil sheet reflects about 80% to about 99% of sunlight, while appearing transparent from inside the building and opaque from outside the building during daytime.

9. The kit according to claim 7, wherein the aluminum has a thickness of between about 0.015 um and about 0.025 um; whereby the foil reflects about 90% to about 99% of sunlight, while appearing transparent from inside the building and opaque from outside the building during daytime.

10. The kit according to claim 5, further comprising a straight edge for holding the sheet down during cutting.

11. The kit according to claim 5, wherein the mounting element includes tape.

12. The kit according to claim 5, further comprising a sponge for applying an adhesive layer to the transparent panel.

13. A heat reflector for use in covering a window to reflect sunlight from entering a building comprising:
a polyethylene substrate layer;
a metallized material in or on the polyethylene substrate layer forming a foil to increase reflectivity to between about 40% and about 99% of the sunlight; and
a mounting element for temporarily mounting the foil onto a window and enabling manual removal and reinstallation at any time.

14. The heat reflector according to claim 13, wherein the polyethylene substrate layer comprises biaxially-oriented polyethylene terephthalate.

15. The heat reflector according to claim 14, wherein the metallized material comprises aluminum.

16. The heat reflector according to claim 15, wherein the aluminum has a thickness of between about 0.0025 um and about 0.025 um; whereby the foil reflects about 80% to about 99% of sunlight, while appearing transparent from inside the building and opaque from outside the building during daytime.

17. The heat reflector according to claim 15, wherein the aluminum has a thickness of between about 0.015 um and about 0.025 um; whereby the foil reflects about 90% to about 99% of sunlight, while appearing transparent from inside the building and opaque from outside the building during daytime.

18. The heat reflector according to claim 13, wherein the mounting element includes an adhesive layer.

19. The heat reflector according to claim 18, wherein the adhesive layer comprises a solution of soap and water.
